(19) United States
(12) Patent Application Publication
(10) Pub. No.: US 2022/0365191 A1
(43) Pub. Date: Nov. 17, 2022

(54) LIDAR SENSOR COMPRISING A VIEWING WINDOW AND A CLEANING UNIT, AND ASSOCIATED SENSOR ASSEMBLY

(71) Applicant: Robert Bosch GmbH, Stuttgart (DE)

(72) Inventor: Alf Neustadt, Stuttgart (DE)

(21) Appl. No.: 17/770,143

(22) PCT Filed: Oct. 21, 2020
(86) PCT No.: PCT/EP2020/079552

§ 371 Date: Apr. 19, 2022

(30) Foreign Application Priority Data
Oct. 25, 2019 (DE) 10 2019 216 440.4

(51) Int. Cl. G01S 7/497; G01S 7/481; G01S 17/04; G01S 17/931; B60S 1/56

(52) U.S. Cl. CPC G01S 7/497; G01S 7/4813; G01S 7/4817; G01S 17/04; G01S 17/931; B60S 1/566; G01S 2007/4977

(57) ABSTRACT

A lidar sensor including a viewing window and a cleaning unit. The lidar sensor has a vertical axis that connects a first side of the lidar sensor to a second side of the lidar sensor opposite the first side. The viewing window is situated on a front side of the lidar sensor, which connects the first side to the second side. The lidar sensor has a rear side, which connects the first side to the second side. The cleaning unit is situated on the front side of the lidar sensor, and extends along a direction of the vertical axis over the front side when the cleaning unit is in a park position. The lidar sensor being suited to be installed and operated on a vehicle in such a way that, optionally, the first side or the second side is an upper side of the lidar sensor.

### FIELD

The present invention relates to a lidar sensor and to an associated sensor system.

### BACKGROUND INFORMATION

Currently, three different classes of lidar sensors are typically used in the automotive field. These include non-automotive lidar systems, typically used for measurement tasks, non-automotive lidar systems used for test drives (and small-series production) in the automotive field, and automotive lidar systems.

In the first two classes, i.e., the non-automotive lidar systems, the appearance, and to some extent also the optical system, of the vehicle integration is rather unimportant. A wide field of view is often required, so that lidar sensors having an active rotor are often used. Here, the lidar systems are mostly symmetrical with respect to their longitudinal axis.

In the automotive lidar systems, the appearance and the integration in the vehicle are very important. Standardly, one lidar sensor per vehicle is used, situated for example in the front grill between the headlights, or in the front fender of the front apron. Here, the lidar sensor is usually situated to the left or to the right of the vehicle center.

Now there is a new class of lidar systems. These are automotive lidar systems that can be used to support autonomous driving in series production vehicles. For this purpose, a plurality of lidar sensors are installed in a vehicle, for example 6 or 7 pieces. Here, the demands made on vehicle integration/appearance are significantly higher than in test vehicles. The field of view of such a lidar sensor is approximately 110-120 degrees horizontally.

In autonomous driving, the requirement of availability of the lidar sensor is significantly greater than in other applications. Thus, it is in particular necessary to keep the field of view of the sensor as free as possible of dirt and droplets, especially when driving in poor weather or precipitation. For this purpose, it is advantageous not only to use sprayed water, but also to clean the viewing window by wiping.

In order to prevent premature wear of a wiper, there should be no impact points/edges in the region of movement of the wiper blade. Advantageously, there is therefore a region of a front screen, and thus a viewing window, of the lidar sensor that is not required for the lidar function and in which the window wiper can be “parked.” This position is called the park position.

This region requires additional space, or makes the housing of the lidar larger. In the case of symmetrical (mirrored) installation positions in the vehicle (e.g., the left and right fender), two different park positions of the wiper (relative to the vehicle) are then required, as well as two different vehicle integrations (due to aerodynamics, exposure of the wiper, field of vision), or two park positions on the lidar, with corresponding additional expansion of the lidar housing.

### SUMMARY

The lidar sensor according to an example embodiment of the present invention includes a viewing window and a cleaning unit, the lidar sensor having a vertical axis that connects a first side of the lidar sensor to a second side of the lidar sensor, the first side and the second side being oppositely situated sides, the viewing window being situated on a front side of the lidar sensor that connects the first side to the second side of the lidar sensor, the lidar sensor having a rear side that connects the first side to the second side of the lidar sensor, the cleaning unit being situated on the front side of the lidar sensor, the cleaning unit extending along a direction of the vertical axis over the front side when the cleaning unit is in a park position, and the lidar sensor being suited to be installed and operated on a vehicle in such a way that, optionally, the first side or the second side is an upper side of the lidar sensor.

In this way a lidar sensor is provided that can also be installed upside down, so that a second park position for the cleaning unit can be omitted, and, given a configuration of a plurality of lidar sensors on a vehicle, a symmetrical realization can nonetheless be ensured. This means that the lidar sensor can be situated in particular on a right side of the vehicle in order to acquire an environment at the right side of the vehicle, or can be situated on a left side of a vehicle in order to acquire an environment at the left side of the vehicle. In this way, a sensor having identical construction can be situated either on a right side or on a left side of a vehicle, thus maintaining a symmetrical appearance of the vehicle. Here it is not necessary to reconfigure a cleaning unit, for example in order to change the park position of the cleaning unit.

In this way, a lidar sensor is provided that can be situated either at the right or at the left on a vehicle, it being possible to make use of sensors having identical design in order to situate these both at the right and also at the left on a vehicle. Due to the fact that the lidar sensor is suited to be situated on the vehicle with, optionally, the first side or the second side as the upper side, the park position can be maintained unchanged, and the appearance of a plurality of lidar sensors on a vehicle remains symmetrical. If, for example, the park position of the cleaning unit on the lidar sensor, with respect to a configuration on the vehicle, is at the side of a front of the vehicle when the lidar sensor is situated on the right side of the vehicle, then it is also at the side of a vehicle front when the lidar sensor is situated at the left side of the vehicle and, instead of the first side, the second side is chosen as the upper side of the lidar sensor, i.e. when the lidar sensor is installed upside down.

In contrast to sensors that are rotated about a vertical axis in order to situate them on an opposite side of the vehicle, it is therefore not necessary to redefine a park position of the cleaning unit in order to obtain a symmetrical appearance. It is thus not necessary to provide different lidar sensors for a different installation position on a vehicle, or to enable a reconfiguration of the park position of the lidar sensor. In addition, the lidar sensor can be built more compactly, because it is not necessary to realize the front side or the viewing window in such a way that different park positions can be traveled to by the cleaning unit depending on whether the lidar sensor is installed at the right or at the left on a vehicle. The first side and the second side are thus the upper side and the lower side of the lidar sensor when this sensor is installed in a vehicle. However, here it is not possible to designate one of the first side and the second side as upper side or as lower side, because both the first side and the second side can be regarded as the upper side, depending on how the lidar sensor is installed in the vehicle. The lidar sensor is suited to be installed and operated on a vehicle in such a way that, optionally, the first side or the second side is an upper side of the lidar sensor. This means, inter alia, that a mechanism in the lidar sensor is designed in such a way that it can be operated independently of whether the first side or the second side is the upper side of the lidar sensor in the situation of the lidar sensor on a vehicle. Thus, in particular bearings in the lidar sensor are designed in such a way that, for example, a deflecting unit in the lidar sensor can be reliably operated independently of which of the first and the second side of the lidar sensor is used as the upper side of the lidar sensor.

The vertical axis of the lidar sensor is not a constructive element, but rather is a virtual axis that describes an orientation of the lidar sensor. The vertical axis of the lidar sensor typically corresponds to the vertical axis of a vehicle when the lidar sensor is installed in the vehicle.

The lidar sensor has a front side having a viewing window. The viewing window is a transparent component through which light beams from the lidar sensor are emitted and reflections from the environment of the lidar sensor are received by the lidar sensor. The first side, the second side, the front side, and the rear side of the lidar sensor are preferably sides of a housing of the lidar sensor. The viewing window preferably extends over the entire front side of the lidar sensor. The front side of the lidar sensor is the side of the lidar sensor that, given an integrated installation of the lidar sensor on a vehicle body, forms a part of an outer surface of the body of the vehicle. Optionally, the front side of the lidar sensor is therefore limited by a sealing lip. The rear side of the lidar sensor is the sides of the lidar sensor that, given an integrated installation of the lidar sensor on a vehicle body, are not visible.

The cleaning unit is preferably a mechanical cleaning unit that, during a cleaning process, is moved over the viewing window, or parts of the viewing window, starting from the park position. The park position can be situated either on the viewing window or next to the viewing window.

The cleaning unit extends along a direction of the vertical axis over the front side when the cleaning unit is in a park position. Here, the cleaning unit preferably extends along the vertical axis over the region of the viewing window that is cleaned by the cleaning unit.

Preferred developments of the present invention are disclosed herein.

Preferably, in accordance with an example embodiment of the present invention, the cleaning unit includes a wiper blade that, in the park position, is situated parallel to the vertical axis. In the park position, the wiper blade can be situated either on the viewing window or next to the viewing window. Here the wiper blade is in particular situated such that it is moved from the park position, i.e., its rest position, over the viewing window in a linear movement, in a direction provided for a wiping. A contact edge of the wiper blade thus preferably runs parallel to the vertical axis.

Preferably, in accordance with an example embodiment of the present invention, the cleaning unit is set up to be moved from the park position over the viewing window, the cleaning unit being moved in a direction of movement that is at a right angle to the vertical axis. This means that the cleaning unit, when it is controlled so as to be moved, is preferably moved over the viewing window in a longitudinal direction that extends between the first and the second side of the lidar sensor. Conversely, this means that the cleaning process is not carried out through a movement that is directed from the top to the bottom. The cleaning process is carried out through a linear movement. A particularly simple construction of the lidar sensor is thus enabled.

In accordance with an example embodiment of the present invention, It is also advantageous if the lidar sensor has a holder that enables a fastening of the lidar sensor and that is shaped such that it is symmetrical to a plane of symmetry that stands perpendicular to the vertical axis. Here, a plane of symmetry is a plane of symmetry of the holder, the plane of symmetry also running through the lidar sensor at mid-height with respect to the vertical axis. The lidar sensor in itself, i.e., the lidar sensor without the holder, is not necessarily symmetrical relative to the plane of symmetry. Thus, in particular in the interior of the lidar sensor components can be situated asymmetrically relative to the plane of symmetry. Plug connections for contacting the lidar sensor are preferably, but not necessarily, configured symmetrically relative to the plane of symmetry. Due to the fact that the holder is symmetrical to the plane of symmetry, holding points at which the holder of the lidar sensor is fastened to a vehicle can be realized symmetrically to one another at different sides of the vehicle.

In addition, it is advantageous if the holder has a central holding point that is situated on the plane of symmetry and/or has two eccentric holding points situated symmetrically on different sides of the plane of symmetry. In particular, a combination of a center holding point and two eccentric holding points is advantageous. The eccentric holding points can secure the lidar sensor particularly effectively against rotation. The center holding point can be realized at particularly low cost, and enables simple mounting of the lidar sensor. In the case of a combination of a center holding point and two eccentric holding points situated in particular on different sides, preferably on opposite sides, on the rear side of the lidar sensor, on the one hand the lidar sensor is secured against rotation, and on the other hand it is secured in its position at both sides. The holding points, and thus the holder, are preferably situated on the rear side of the lidar sensor.

In addition, it is advantageous if the front side having the viewing window is shaped such that it is symmetrical to a plane of symmetry that is perpendicular to the vertical axis. In this way, it is ensured that an appearance of the lidar sensor is independent of whether it is situated on a right side or a left side of the vehicle.

In accordance with an example embodiment of the present invention, it is also advantageous if the lidar sensor has a longitudinal axis that runs along the front side and stands perpendicular to the vertical axis, and an optical center of the lidar sensor lies on the longitudinal axis at a distance from a geometrical center of the lidar sensor. In particular, a field of view of the lidar sensor is oriented such that the lidar sensor runs through the front side, with the associated viewing window, in a region such that only a single further region remains on the front side that is adequately large to form the park position for the cleaning unit. The optical sensor is a point from which a scanning beam apparently emanates, in an external view of the lidar sensor, when the scanning beam runs in linear fashion and without deflection before exiting from the lidar sensor. This means that the scanning beam of the lidar sensor runs through the viewing window on the front side in such a way that at least on one side sufficient space remains to bring the cleaning unit to a park position at this location without hindering a path of the beam of the lidar sensor. Also preferably, the scanning beam of the lidar sensor runs through the viewing window on the front side in such a way that on another side there does not remain enough space to bring the cleaning unit into a park position at this location without hindering a path of a beam of the lidar sensor. At the same time, it is advantageous if a direction of view of the lidar sensor is directed towards a front of the vehicle or towards a rear of the vehicle, i.e. in a particular direction along the longitudinal axis. The lidar sensor can thus look in a particular direction. The field of view of the lidar sensor may be asymmetrical.

In accordance with an example embodiment of the present invention, it is also advantageous if a scanning direction of the lidar sensor, in particular a direction of rotation of a rotating deflecting unit of the lidar sensor, is configurable. Thus, the scanning direction of the lidar sensor can for example be set to rotate to the right if the lidar sensor is installed at a right side of the vehicle, and the scanning direction of the lidar sensor can be set to rotate to the left if the lidar sensor is installed at a left side of the vehicle.

Alternatively, the scanning direction of the lidar sensor can for example be set to rotate to the right if the lidar sensor is installed at a left side of the vehicle, and the scanning direction of the lidar sensor can be set to rotate to the left if the lidar sensor is installed at a right side of the vehicle. Because the lidar sensor is provided to be installed upside down at one of the sides of the vehicle, in this way it can be achieved that a scanning direction of different lidar sensors is the same relative to the vehicle. In this way, the scanning beams of different lidar sensors can be prevented from running into one another and influencing one another.

In accordance with an example embodiment of the present invention, it is also advantageous if the lidar sensor is set up to receive a synchronization signal that makes it possible to synchronize a scanning process of the lidar sensor with a specified time frequency and/or a specified phase. The time frequency of the scanning process is here determined by how long the lidar sensor needs to acquire its field of view one time. The repeated one-time acquisition of the field of view yields the time frequency. Thus, via the synchronization signal the speed with which the lidar sensor acquires its environment can be set. The phase of the lidar sensor and the scanning process of the lidar sensor define when the scanning beam of the lidar sensor is at a particular location. Due to the fact that the time frequency and the phase of the scanning process of the lidar sensor can be set by the synchronization signal, in particular thus defining the phase and the time frequency in the synchronization signal, a plurality of lidar sensors can be synchronized to one another, for example in such a way that their scanning beams do not run into one another.

In addition, a sensor system in accordance with an example embodiment of the present invention is advantageous that includes at least two lidar sensors according to the present invention, a first side of one of the lidar sensors and the second side of another of the lidar sensors being situated on a common side. Here, the sensor system is in particular a sensor system on a vehicle, one of the lidar sensors being situated at a first side of the vehicle and the other of the lidar sensors being situated at the opposite side of the vehicle. The sensor system has all the advantages of the individual lidar sensors, while being particularly economical to provide as a symmetrical sensor system.

### BRIEF DESCRIPTION OF THE DRAWINGS

In the following, exemplary embodiments of the present invention are described in detail with reference to the figures.

FIG. 1 shows a schematic representation of a lidar sensor according to a specific example embodiment of the present invention.

FIG. 2 shows a schematic representation of the lidar sensor according to the present invention in a cross-section.

FIG. 3 shows a schematic representation of the lidar sensor according to the present invention in a side view.

FIG. 4 shows a schematic representation of the lidar sensor from a rear view.

FIG. 5 shows a sensor system in which the lidar sensor is situated on the front of a vehicle.

FIG. 6 shows a sensor system in which a plurality of lidar sensors are situated on a vehicle.

### DETAILED DESCRIPTION OF EXAMPLE EMBODIMENTS

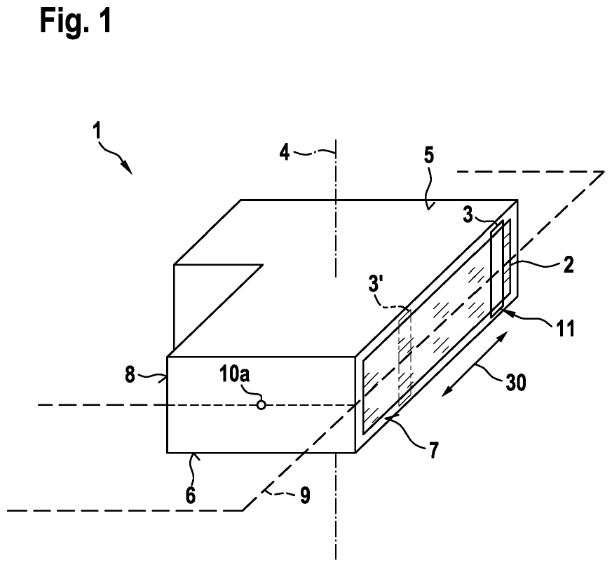

FIG. 1 shows a schematic representation of a lidar sensor 1 according to the present invention. Here, lidar sensor 1 is shown in an external view, a housing of lidar sensor 1 being shown in FIG. 1.

Lidar sensor 1 has a first side 5 and a second side 6. In FIG. 1, first side 5 is shown at the top, and in FIG. 1 second side 6 is a lower side in the depicted representation of lidar sensor 1, which lower side however is not visible in the perspective view. First side 5 and second side 6 of the lidar sensor are configured in such a way that these sides are run through by a vertical axis 4 of lidar sensor 1, and are thus connected by vertical axis 4. Here, vertical axis 4 is only a virtual axis that is shown in FIG. 1 in order to define an orientation of individual components of lidar sensor 1. Vertical axis 4 is not a constructive element of lidar sensor 1. First side 5 and second side 6 of lidar sensor 1 are thus two opposite sides of lidar sensor 1. Depending on how lidar sensor 1 is situated in space, first side 5 is an upper side of the lidar sensor or second side 6 is an upper side of lidar sensor 1. Correspondingly, either first side 5 is a lower side of lidar sensor 1 or second side 6 is a lower side of lidar sensor 1.

Lidar sensor 1 has a front side 7 on which there is situated a transparent viewing window 2 of lidar sensor 1. Viewing window 2 preferably extends over the entire front side 7, but can also cover only a partial region of front side 7. The front side 7 of lidar sensor 1 connects first side 2 to second side 6. Here, front side 7 of lidar sensor 1 is a side of lidar sensor 1 that, given a constructive situation of lidar sensor 1 on a vehicle, typically terminates flush with a body of the vehicle. Here, lidar sensor 1 is typically situated on a vehicle in such a way that only front side 7 is visible. Therefore, front side 7 can in particular also be shaped such that it has a certain curvature so that it will optimally fit into a body shape.

In addition, lidar sensor 1 has a rear side 8 that connects first side 5 to second side 6 of lidar sensor 1. Here the other sides of lidar sensor, which connect the first side to the second side 5, 6, but do not belong to front side 7 of lidar sensor 1, are regarded as rear side 8 of lidar sensor 1. Rear side 8 of lidar sensor 1 is formed by those sides of lidar sensor 1 that, given a constructive situation of lidar sensor 1 on a vehicle, are typically concealed by the body.

A cleaning unit 3 is situated on front side 7 of lidar sensor 1. Cleaning unit 3 includes a wiper blade that is mounted movably in order to be moved over viewing window 2. In alternative specific embodiments, cleaning unit 3 is for example a brush or a system of a plurality of blades. Cleaning unit 3 enables a cleaning of viewing window 2. Here, cleaning unit 3, and thus the wiper blade, are moved in a direction of movement that is at a right angle to vertical axis 4. This direction of movement is indicated in FIG. 1 by double arrow 30. A precise movement path of cleaning unit 3 with the wiper blade results from a surface shape of front side 7 and of viewing window 2. In order to achieve a cleaning effect on viewing window 2, it is necessary for cleaning unit 3 to be continuously in contact with viewing window 2 when the unit is moved over viewing window 2. In order to achieve a cleaning effect and to cover the entire height of viewing window 2, the wiper blade of cleaning unit 3 is configured parallel to vertical axis 4.

If cleaning unit 3 is not required, then this unit is brought to, to a park position 11 at a particular location on front side 7, in which position the wiper blade of cleaning unit 3 is situated parallel to vertical axis 4. In other words, a particular position is defined to which cleaning unit 3 is brought when this unit is not needed. This position is also situated on front side 7. In order to ensure that a field of view of lidar sensor 1 is not limited by cleaning unit 3, it is necessary for front side 7 to be correspondingly dimensioned, so that the field of view of lidar sensor 1 through viewing window 2 is possible without limitation, and adequate space is provided on front side 7 to enable cleaning unit 3 to be moved into park position 11.

In current vehicle systems, it is often necessary to situate a plurality of lidar sensors on one vehicle. Thus, for example a plurality of the lidar sensor 1 shown in FIG. 1 are situated on a vehicle. Lidar sensor 1 is suited to be installed and operated on a vehicle 20 in such a way that, optionally, first side 5 or second side 6 is an upper side of lidar sensor 1. It can be seen that the lidar sensor 1 shown in FIG. 1, after a rotation in order to rotate the upper first side 5 in FIG. 1 downward, cleaning unit 3 remains at the same position with regard to its direction of movement. In other words, when lidar sensor 1 shown in FIG. 1 is installed on a vehicle in such a way that park position 11 is oriented in the direction of a front of the vehicle on front side 7, park position 11 also lies on front side 7 in the direction of the vehicle front when lidar sensor 1 is rotated by 180°, i.e. is turned upside down in order to rotate first side 5 downward. From this it results that park position 11 relative to vehicle 100, in which two of the lidar sensors 1 shown in FIG. 1 are installed, one of the lidar sensors 1 being installed at a right side of vehicle 100 and one of the lidar sensors 1 being installed at a left side of vehicle 100, park position 11 of cleaning unit 3 of the two lidar sensors 1 would enable a symmetrical appearance of the two lidar sensors 1 on vehicle 100. This is possible even though lidar sensor 1 is identical in construction at the right side of vehicle 30 and at the left side of vehicle 30. This would not be possible if lidar sensor 1 were merely rotated by 180° about vertical axis 4, because in this case park position 11 would travel from a front side of vehicle 30 to a rear side of vehicle 30. It would then be necessary to define a second park position 11. However, this would have the result that lidar sensor 1 would have to be made with a larger dimension of front side 7 in order not to limit a field of view of lidar sensor 1, regardless of how park position 11 is configured on lidar sensor 1.

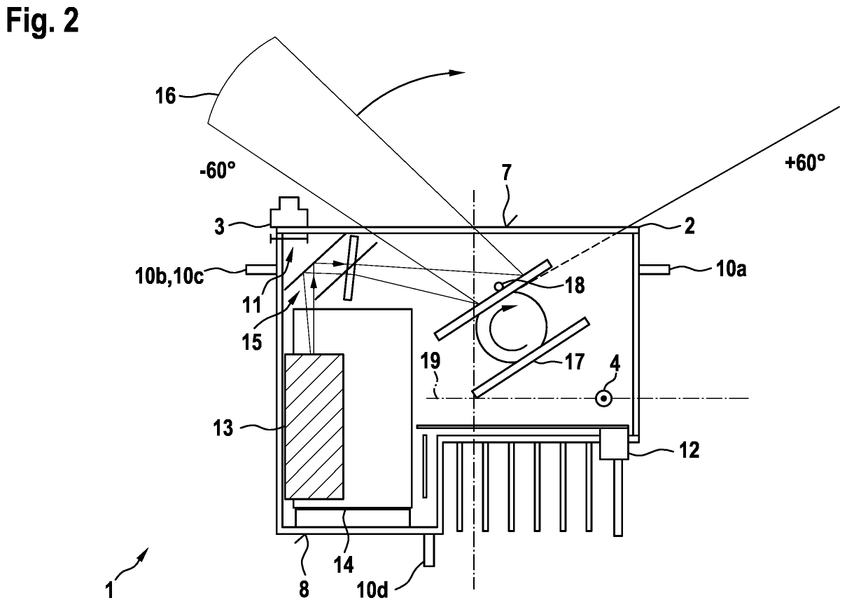

FIG. 2 shows lidar sensor 1 shown in FIG. 1 in a sectional view. Here it can be seen that on a side inside lidar sensor 1 there is situated an optical transmit unit 13 and an optical receive unit 14. Thus, optical transmit unit 13 projects a scanning beam 16 of lidar sensor 1, in particular a laser beam, onto an optical system 15, and the beam is reflected by this optical system onto a deflecting unit 17. Here, deflecting unit 17 is a rotating mirror system that rotates in a specified direction of rotation. Scanning beam 16 is projected onto a rotating mirror of the rotating mirror system, and, deflected by this and through viewing window 2, scanning beam 16 is radiated into an environment of lidar sensor 1. Here, lidar sensor 1 for example acquires a field of view of −60° to +60°. Thus, lidar sensor 1 has a field of view that extends symmetrically, going out from front side 7 of lidar sensor 1. Here it can be seen that viewing window 2, and thus also front side 7, are completely used in order both to radiate scanning beam 16, by an angle of −60° to +60°, through viewing window 2 and at the same time to enable cleaning unit 3 to remain in a park position 11 without interrupting scanning beam 16.

For completeness, it is noted that reflected scanning beam 16, which was reflected by an object in the environment of lidar sensor 1, is reflected via deflecting unit 17, i.e. via the rotating mirror, onto optical system 15, and is reflected by this onto optical receive unit 14. Reflected scanning beam 16 here follows the optical path of the transmitted scanning beam 16, up to optical system 15. Correspondingly, in this way reflected scanning beam 16 is also not interrupted by cleaning unit 3 when this unit is in park position 11.

FIG. 2 shows an optical center 18 of lidar sensor 1. Optical center 18 is here the point from which scanning beam 16 of lidar sensor 1 goes out when lidar sensor 1 is viewed from outside through viewing window 2. Here it can be seen that optical center 18 of lidar sensor 1 is offset relative to the geometrical center of lidar sensor 1. Thus, lidar sensor 1 has a longitudinal axis 19 that runs parallel to front side 7 and stands perpendicular to vertical axis 4. Along this longitudinal axis 19, optical center 18 is not situated centrically in lidar sensor 1, but rather is situated on longitudinal axis 19 at a distance from the geometrical center of lidar sensor 1. In this way, adequate space is provided on front side 7 for cleaning unit 3 when this unit is in park position 11.

In other words, when viewing the front side 7 of lidar sensor 1, optical center 18 is offset to the right or to the left relative to the center of front side 7. This offset is also an offset along longitudinal axis 19. In particular, here a distance from an edge of front side 7 to the side of park position 11 of cleaning unit 3 is greater than a distance from an edge, situated opposite an edge, of front side 7. It is to be noted that in FIG. 2 longitudinal axis 19 is shown as an example, and is defined only by its orientation. Thus, in a corresponding representation of longitudinal axis 19, optical center 18 is situated on longitudinal axis 19.

Optionally, lidar sensor 1 has a field of view that extends asymmetrically going out from front side 7 of lidar sensor 1. Lidar sensor 1 can thus have a directed direction of view. This means that a field of view of lidar sensor 1 can be larger in one direction than in another direction.

In the view of lidar sensor 1 shown in FIG. 2, the direction of rotation of deflecting unit 17 is shown as rotating to the right. The direction of rotation of rotating deflecting unit 17 is here configurable. This means that the direction of rotation can also be configured as rotating to the left. This makes it possible to reverse a scanning direction, i.e. a direction of movement of scanning beam 16. In this way, when lidar sensor 1 is installed upside down, it is possible to maintain the direction of movement of scanning beam 16 of lidar sensor 1 relative to the vehicle by reversing the direction of rotation of rotating deflecting unit 17.

FIG. 2 shows an installation design of lidar sensor 1. Here, the center of the field of view is lateral to a sensor center, and there is a “dead” region of field viewing window 2, at which cleaning unit 3 can be parked. The installation on vehicle 100 preferably takes place symmetrically, for example in the fenders. Cleaning unit 3 is parked in a “niche.” The body of vehicle 100 can be optimized for the field of view of lidar sensor 1. The respective other side of the body of vehicle 100 is mirrored, and does not have to be separately optimized. The internal design of the body, for example of the fender, can also be made symmetrical, including cable routing, cooling air routing, etc.

Reference is made to FIG. 1. Front side 7, having viewing window 2, of lidar sensor 1 is shaped in such a way that it is symmetrical to a plane of symmetry 9 that stands perpendicular to vertical axis 4. Thus, an upper half of front side 7 is symmetrical to a lower half of front side 7. In this way, it is achieved that the appearance presented by lidar sensor 1 in its installed state is the same regardless of whether first side 5 or second side 6 is used as upper side of lidar sensor 1.

In order to enable a fastening of lidar sensor 1, lidar sensor 1 has a holder 10. This holder enables for example lidar sensor 1 to be fastened to a vehicle. Holder 10 is situated on the housing of lidar sensor 1 in such a way that this sensor is symmetrical to plane of symmetry 9, which stands perpendicular to vertical axis 4. In this way, lidar sensor 1 can be fastened to a body of a vehicle 100 that is also made symmetrical.

In this specific embodiment, holder 10 has a center holding point 10a and two holding points 10b, 10c offset from the center. Here, center holding point 10a is situated so as to lie on plane of symmetry 9, and the two eccentric holding points 10b, 10c are situated so as to lie symmetrically on different sides of plane of symmetry 9. Here, plane of symmetry 9 is the same plane of symmetry 9 that also divides front side 7 into two halves symmetrical to one another. Regarding the symmetry of lidar sensor 1, it is to be noted that the design of lidar sensor 1 as a whole is not necessarily symmetrical. Thus, for example terminals 12 of lidar sensor 1 on rear side 8 may be realized in asymmetrical fashion, and optical transmit unit 13 and optical receive unit 14, as well as optics system 15, may be asymmetrical relative to plane of symmetry 9. Terminals 12, for example one or more plug connectors, are preferably situated at an outer edge of lidar sensor 1 in order to enable easy actuation.

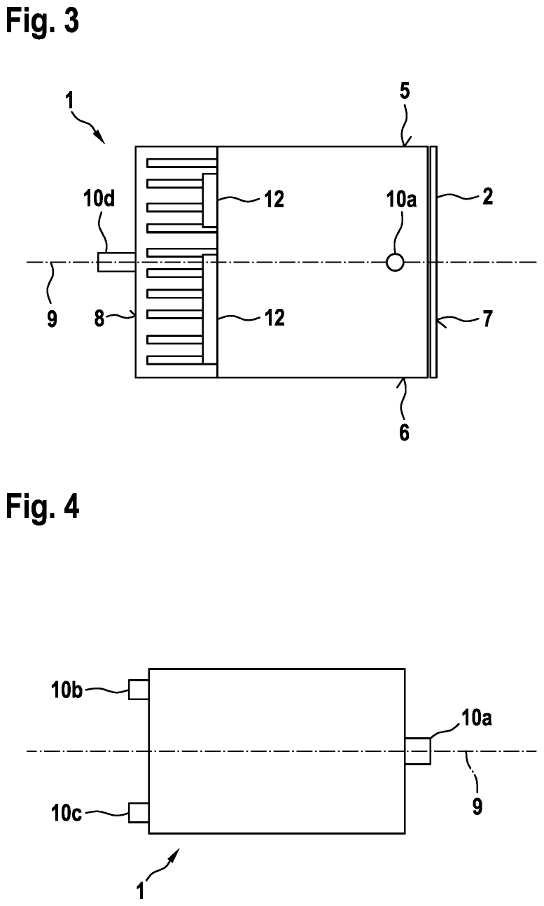

In FIGS. 3 and 4, holding points 10a, 10b, 10c are again shown. Here, a side view of lidar sensor 1 is shown in FIG. 3, it can be seen that first holding point 10a is situated on plane of symmetry 9, which runs through lidar sensor 1 at the halfway point between first side 5 and second side 6, parallel to first side 5 and to second side 6. In addition, it can be seen from FIG. 3 that a further holding point 10d is situated on the rear side of lidar sensor 1, on plane of symmetry 9. Rear additional holding point 10d may be configured asymmetrically to the center axis of lidar sensor 1.

A configuration of the two eccentric holding points 10b, 10c is shown in FIG. 4. Here, a first eccentric holding point 10b is situated at the same distance from plane of symmetry 9 as is a second eccentric holding point 10c. In particular, a combination of the eccentric holding points 10b, 10c and center holding point 10a is advantageous. This is also shown schematically in FIG. 4. In particular, rotation of lidar sensor 1 can be prevented by eccentric holding points 10b, 10c. At the same time, a fastening of lidar sensor 1 is simplified by center holding point 10a, and by the combination of the holding points, which together span a triangle, a stable configuration of lidar sensor 1 after its fastening is enabled.

Lidar sensor 1 is set up to receive a synchronization signal that makes it possible to synchronize a scanning process of lidar sensor 1 with a specified time frequency and/or a specified phase. The synchronization signal is for example received via terminals 12 on rear side 8 of lidar sensor 1. Here it is advantageous if the synchronization signal carries an item of information that specifies the time frequency and/or the phase to which lidar sensor 1 is to be synchronized. In this way, given the use of a plurality of lidar sensors 1, a current position of scanning beams 16 of the two lidar sensors 1 can be calibrated to one another, so that an intersection of the scanning beams and an irritation of lidar sensor 1 can be avoided.

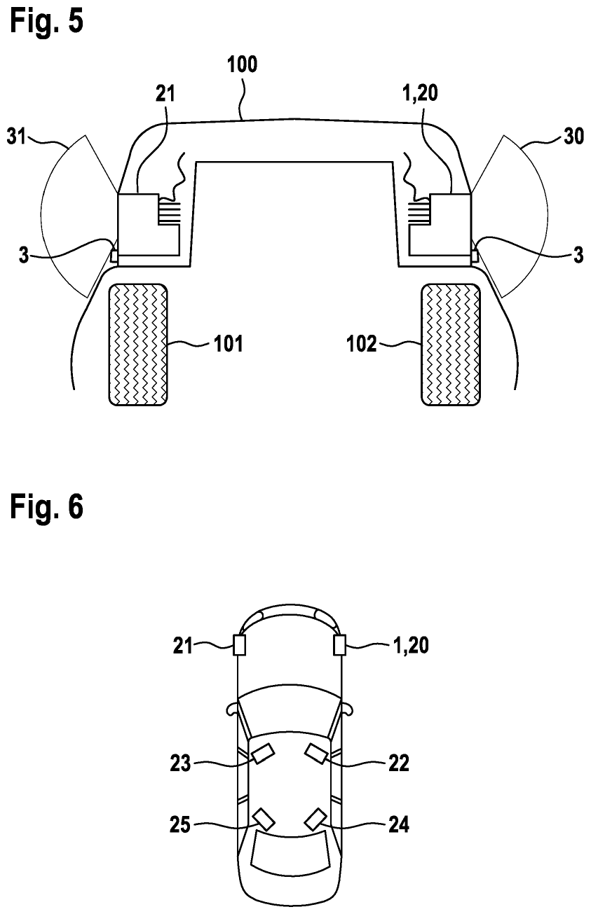

Lidar sensor 1 is realized in such a way that it can be used particularly preferably on a vehicle in combination with a plurality of lidar sensors 1 having identical construction. An example of a configuration of two lidar sensors 1 according to the present invention on a vehicle 100 is shown in FIG. 5. Here, in FIG. 5 a vehicle front is shown, a first lidar sensor 20, which corresponds to lidar sensor 1 described above, being situated on a right side of the vehicle front, and a second lidar sensor 21, which is identical in construction to first lidar sensor 20, being situated on a left side of the front of vehicle 100. Here, the two lidar sensors 20, 21 are, as an example, situated in front of the front wheels 101, 102 of vehicle 100. Thus, lidar sensors 20, 21 are for example situated in a bumper of vehicle 100. It can be seen that first lidar sensor 20 has field of view 30 that is directed towards a right side of vehicle 100. Correspondingly, second lidar sensor 21 has a field of view 31 directed to a left side of vehicle 100. First lidar sensor 20 is here situated in such a way that first side 5 of first lidar sensor 20 and second side 6 of the rest of the lidar sensors, i.e. of second lidar sensor 21, are situated on a common side. Thus, in FIG. 5 first side 5 of first lidar sensor 20 and second side 6 of second lidar sensor 21 are visible. Cleaning units 3 of the two lidar sensors 20, 21 are in park position 11, and are placed on front side 7 of the respectively associated lidar sensor 1 so as to be oriented toward the rear of vehicle 100. Thus, the same park position 11 at which cleaning unit 3 in FIG. 5 is situated is used. In addition, it is advantageous if a multiplicity of lidar sensors 1 having identical construction are situated on a vehicle 100. An example of a sensor configuration is shown in FIG. 6. Here, in addition to first lidar sensor 20 and second lidar sensor 21, a third lidar sensor 22, a fourth lidar sensor 23, a fifth lidar sensor 24, and a sixth lidar sensor 26 are also situated on vehicle 100. Here, first through sixth lidar sensors 20 through 26 are lidar sensors having the same construction. It can be seen that lidar sensors 20 through 26 do not necessarily have to be oriented parallel to a longitudinal axis of vehicle 100. Rather, the individual lidar sensors 20 through 25 can be situated in any manner on vehicle 100, an aesthetic optical effect and optimal aerodynamic properties being maintained if these sensors are configured symmetrically on vehicle 100 with respect to a longitudinal axis of vehicle 100. Thus, lidar sensor 1 can for example be situated at any of the positions shown in FIG. 6, and a symmetrical overall appearance of vehicle 100 can be maintained.

Thus, lidar sensor 1 is constructed such that it can also be installed upside down. In this way, a widening of lidar sensor 1 can be done without in order to create space for park position 11, and the construction in vehicle 100 can be made symmetrical.

For this purpose, it is advantageous if the fastening of lidar sensor 1 in the vehicle (fastening points) are also laid out symmetrically to the z axis, i.e. to vertical axis 4, ideally at half the height of lidar sensor 1.

A non-center position in the horizontal direction of optical center 18 of lidar sensor 1 can additionally help to improve the vehicle integration, in particular with respect to the field of view.

In order to minimize mutual disturbances between lidar sensors 1 when a plurality of the sensors are situated on a vehicle, lidar sensors 1 are synchronized to a common time frequency, and the movements of deflecting units 17 relative to the vehicle are coordinated in such a way that at all times lidar sensors 1 look in different directions and their movements do not intersect one another. In the case of a rotatable lidar sensor 1 having rotary deflection, for this purpose the direction of rotation of deflecting units 17 relative to lidar sensor 1 is made reversible, and lidar sensors 1 on the right side of the vehicle are configured having a different direction of rotation from lidar sensors 1 on the left side of the vehicle.

Advantageously, the movements of deflecting unit 17 are synchronized in such a way that scans take place in the same direction relative to vehicle 100 at uniform temporal intervals. Thus, for example given a 100 ms repetition rate per lidar sensor 1, two of the lidar sensors 1 are configured such that the two lidar sensors 1 alternately scan the region at the front of a vehicle every 50 ms.

In addition to the above disclosure, explicit reference is made to the disclosure of FIGS. 1 through 6.

1-10. (canceled)

11. A lidar sensor, comprising:
a viewing window; and
a cleaning unit:
wherein the lidar sensor has a vertical axis that connects a first side of the lidar sensor to a second side of the lidar sensor, the first side and the second side being oppositely situated sides,
wherein the viewing window is situated on a front side of the lidar sensor, which connects the first side of the lidar sensor to the second side of the lidar sensor,
wherein the lidar sensor has a rear side, which connects the first side of the lidar sensor to the second side of the lidar sensor;
wherein the cleaning unit is situated on the front side of the lidar sensor, the cleaning unit extending along a direction of the vertical axis over the front side when the cleaning unit is in a park position, and
wherein the lidar sensor is configured o be installed and operated on a vehicle in such a way that, optionally, the first side or the second side is an upper side of the lidar sensor.

12. The lidar sensor as recited in claim 11, wherein the cleaning unit includes a wiper blade that, in the park position, is situated parallel to the vertical axis.

13. The lidar sensor as recited in claim 11, wherein the cleaning unit is configured to be moved from the park position over the viewing window, the cleaning unit being moved in a direction of movement that is at a right angle to the vertical axis.

14. The lidar sensor as recited in claim 11, wherein the lidar sensor has a holder that enables a fastening of the lidar sensor and is shaped in such a way that it is symmetrical to a plane of symmetry that stands perpendicular to the vertical axis.

15. The lidar sensor as recited in claim 14, wherein the holder includes a centric holding point that is situated on the plane of symmetry and/or has two eccentric holding points that are situated symmetrically on different sides of the plane of symmetry.

16. The lidar sensor as recited in claim 11, wherein the front side having the viewing window is shaped such that it is symmetrical to a plane of symmetry that stands perpendicular to the vertical axis.

17. The lidar sensor as recited in claim 11, wherein the lidar sensor has a longitudinal axis that runs along the front side and stands perpendicular to the vertical axis, and an optical center of the lidar sensor lies on the longitudinal axis at a distance from a geometrical center of the lidar sensor.

18. The lidar sensor as recited in claim 11, wherein a direction of rotation of a rotating deflecting unit of the lidar sensor is configurable.

19. The lidar sensor as recited in claim 11, wherein the lidar sensor is set up to receive a synchronization signal that makes it possible to synchronize a scanning process of the lidar sensor with a specified time frequency and/or a specified phase.

20. A sensor system, comprising:
at least two lidar sensors, each including:
a viewing window; and
a cleaning unit:
wherein the lidar sensor has a vertical axis that connects a first side of the lidar sensor to a second side of the lidar sensor, the first side and the second side being oppositely situated sides,
wherein the viewing window is situated on a front side of the lidar sensor, which connects the first side of the lidar sensor to the second side of the lidar sensor,
wherein the lidar sensor has a rear side, which connects the first side of the lidar sensor to the second side of the lidar sensor;
wherein the cleaning unit is situated on the front side of the lidar sensor, the cleaning unit extending along a direction of the vertical axis over the front side when the cleaning unit is in a park position, and
wherein the lidar sensor is configured o be installed and operated on a vehicle in such a way that, optionally, the first side or the second side is an upper side of the lidar sensor;
the first side of one of the lidar sensors and the second side of another of the lidar sensors being situated on a common side.
